(19) United States
(12) Patent Application Publication
(10) Pub. No.: US 2019/0359495 A1
(43) Pub. Date: Nov. 28, 2019

(54) CARBONATE COMPOSITIONS AND METHODS OF USE THEREOF

(71) Applicant: Imerys USA, Inc., Roswell, GA (US)

(72) Inventors: Virendra SINGH, Decatur, GA (US); Claire THERON, Suwanee, GA (US); David TAYLOR, Marietta, GA (US); Christopher PAYNTER, Atlanta, GA (US); Douglas WICKS, Johns Creek, GA (US)

(21) Appl. No.: 16/332,151

(22) PCT Filed: Sep. 11, 2017
(86) PCT No.: PCT/US17/50923

§ 371 Date: Mar. 11, 2019

Related U.S. Application Data
(60) Provisional application No. 62/393,336, filed on Sep. 12, 2016.

(51) Int. Cl. C01F 11/18; C01F 5/24; C08F 210/02; C08F 210/06; C08K 3/01; C09K 8/504; C09K 8/508

(52) U.S. Cl. CPC C01F 11/185; C01F 5/24; C08F 210/02; C08F 210/06; C01P 2006/60; C09K 8/5045; C09K 8/508; C01P 2004/61; C01P 2006/12; C08K 3/01

(57) ABSTRACT

Compositions comprising calcium carbonate, methods of preparation thereof, and methods of use thereof are discussed. The particulate mineral may be prepared by a precipitation process and/or by a grinding process, for example. The composition may comprise a particulate mineral that comprises calcium carbonate and magnesium, wherein the particulate mineral comprises from about 7% to about 80% magnesium by weight, with respect to the total weight of the particulate mineral. The bulk chemical composition of the particulate mineral may have a magnesium content within 5% of the magnesium content of the surface of the particulate mineral, and/or the particulate mineral may have a steepness value ranging from about 20 to about 80.

### TECHNICAL FIELD

Embodiments of the present disclosure relate generally to compositions comprising calcium carbonate, methods of preparation thereof, and methods of use thereof.

### BACKGROUND

Calcium carbonate, including ground calcium carbonate and precipitated calcium carbonate, is useful for many applications. However, calcium carbonate degrades or dissolves when exposed to acid, which can limit that utility. For example, calcium carbonate can react with acids to release carbon dioxide and a soluble calcium (Ca²⁺) salt, and also can react with water saturated with carbon dioxide to form soluble calcium bicarbonate. Further, natural deposits of calcium carbonate minerals are typically heterogeneous with an uneven, inconsistent chemical composition, which can result in unpredictable reaction and/or dissolution characteristics. For some applications, particularly commercial and industrial applications, this susceptibility to degradation and/or variability in chemical and physical characteristics can be undesirable.

### SUMMARY OF THE DISCLOSURE

The present disclosure includes particulate minerals that comprise calcium carbonate and magnesium, compositions comprising such particulate minerals, methods of preparing such particulate minerals, and methods of using such particulate minerals.

According to some aspects of the present disclosure, for example, the composition comprises a particulate mineral that comprises calcium carbonate and magnesium; wherein the particulate mineral comprises from about 7% to about 80% magnesium by weight, with respect to the total weight of the particulate mineral; wherein a bulk chemical composition of the particulate mineral has a magnesium content within 5% of a magnesium content of a surface chemical composition of the particulate mineral; and wherein the particulate mineral has a steepness value ranging from about 20 to about 80. The bulk chemical composition of the particulate mineral may be the same as the surface chemical composition of the particulate mineral and/or the magnesium may be uniformly distributed throughout the particulate mineral. The particulate mineral may have a formula MgₓCO₃Ca_{y}CO₃, wherein x and y are each greater than zero, and x is not 1 if y is 1. In some aspects, for example, x ranges from 2 to 80 and y ranges from 20 to 95.

According to some aspects, the particulate mineral may comprise from about 40% to about 60% magnesium by weight, with respect to a total weight of the particulate mineral. Additionally or alternatively, the particulate mineral may have an average particle diameter ranging from about 3 μm to about 80 μm, such as from about 5 μm to about 10 μm. In some examples, the particulate mineral may have a BET surface area less than about 20 M²/g. In some examples, the particulate mineral may have a GE brightness ranging from about 60 to about 90, or from about 80 to about 90.

In some examples, the particulate mineral may further comprise phosphoric acid and/or a polymer or a co-polymer. For example, the particulate mineral may be in the form of composite particles comprising a polymer or a co-polymer. Exemplary polymers and copolymers include, but are not limited to, acrylic polymers, copolymers of styrene and butadiene, copolymers of acrylonitrile and butadiene, copolymers of diisobutylene and maleic anhydride, maleated butadiene, maleated polyethylene, maleated propylene, and combinations thereof. In some examples, at least a portion of the particulate mineral is derived from a man-made material, such as a post-consumer material. For example, the particulate mineral may comprise recycled calcium carbonate.

The particulate mineral of the compositions herein may be acid resistant. For example, the particulate mineral may have an acid dissolution profile corresponding to a pH less than 7.0 after 30 minutes of adding 1 g of the particulate mineral to 100 ml of an aqueous solution comprising citric acid monohydrate, sodium chloride, and sodium hydroxide, the aqueous solution having an initial pH of about 3.8. In at least one example, the pH of the aqueous solution may range from 3.8 to 5.8 after 60 minutes of adding the particulate mineral to the aqueous solution. In at least one example, the pH of the aqueous solution may range from 3.8 to 5.9 after 120 minutes of adding the particulate mineral to the aqueous solution.

An exemplary composition according to the present disclosure comprises calcium carbonate and magnesium, wherein the particulate mineral comprises from about 7% to about 80% magnesium by weight, with respect to the total weight of the particulate mineral; wherein the particulate mineral has an acid dissolution profile corresponding to a pH between 3.8 and 6.8 after 60 minutes of adding 1 g of the particulate mineral to 100 ml of an aqueous solution comprising citric acid monohydrate, sodium chloride, and sodium hydroxide, the aqueous solution having an initial pH of about 3.8; and wherein the particulate mineral has a steepness value ranging from about 20 to about 80. For example, the pH of the aqueous solution may range from 3.8 to 5.9 after 120 minutes of adding the particulate mineral to the aqueous solution. According to some aspects, the surface chemical composition and/or the bulk chemical composition of the particulate mineral has a formula MgₓCO₃Ca_{y}CO₃, wherein x and y are each greater than zero, and x is not 1 if y is 1. For example, x may range from 2 to 80 or from 10 to 70, and y may range from 20 to 95 or from 30 to 95. In another example, x may range from 30 to 50, and y may range from 20 to 90. The composition and/or the particulate mineral of the composition may have any of the features or characteristics discussed above or elsewhere herein.

According to some aspects of the present disclosure, the composition may comprise two or more different particulate minerals. For example, the particulate mineral may be a first particulate mineral, and the composition may further comprise a second particulate mineral having a chemical composition different than the chemical composition of the first particulate mineral and/or a particle size distribution different than the particle size distribution of the first particulate mineral. In at least one example, the first particulate mineral may have a d₅₀ particle diameter ranging from about 0.5 μm to about 75 μm, and/or the second particulate mineral may have a d₅₀ particle diameter ranging from about 3 μm to about 75 μm. The d₅₀ particle diameter of the first particulate mineral may be greater than, or less than, the d₅₀ particle diameter of the second particulate mineral. In at least one example, the first particulate mineral may have a surface chemical composition of formula MgₓCO₃Ca_{y}CO₃, wherein x and y are each greater than zero, and the second particulate mineral may comprise ground calcium carbonate.

Another exemplary composition according to the present disclosure comprises a particulate mineral that comprises calcium carbonate and a copolymer chosen from a styrene-butadiene copolymer, an acrylonitrile butadiene copolymer, maleated butadiene, maleated polyethylene, maleated propylene, or a mixture thereof; wherein the particulate mineral comprises from about 7% to about 80% of the copolymer by weight, with respect to the total weight of the particulate mineral; wherein a bulk chemical composition of the particulate mineral has a copolymer content within 5% of a copolymer content of a surface chemical composition of the particulate mineral; and wherein the particulate mineral has a steepness value ranging from about 20 to about 80. In at least one example, the copolymer comprises latex. The composition and/or the particulate mineral of the composition may have any of the features or characteristics discussed above or elsewhere herein.

Yet another exemplary composition according to the present disclosure comprises calcium carbonate and magnesium, wherein the magnesium is evenly distributed throughout the composition, and the composition comprises from about 7% to about 80% magnesium by weight, with respect to the total weight of the composition; wherein the composition is acid resistant, and wherein the composition has a GE brightness ranging from about 60 to about 90, such as from about 80 to about 90. The composition may have any of the features or characteristics discussed above or elsewhere herein.

The compositions discussed above and elsewhere herein may be in the form of a powder, e.g., the particulate mineral being in the form of a powder, may be in the form of a liquid, e.g., the particulate mineral in combination with a liquid, or may be in the form of a solid, e.g., the particulate mineral being formed into a solid article, optionally with one or more other materials.

According to some aspects of the present disclosure, for example, the composition may comprise a liquid in combination with the particulate mineral, such that the composition forms a slurry. For example, the composition may comprise a water-based liquid, an oil-based liquid, or an oil-water liquid mixture. In some examples, the composition may be a drilling fluid, e.g., having a particulate mineral concentration ranging from about 1 kg/m³ to about 200 kg/m³, such as from about 5 kg/m³ to about 100 kg/m³, from about 50 kg/m³ to about 150 kg/m³, from about 25 kg/m³ to about 75 kg/m³, or from about 100 kg/m³ to about 175 kg/m³. In other aspects of the present disclosure, the composition may be in the form of an article, such as a packaging material, or a structure having a flat working surface, such as a countertop.

The present disclosure further includes methods of preparing the particulate minerals and compositions discussed above and elsewhere herein. For example, a particulate mineral comprising calcium carbonate and magnesium may be prepared by combining lime, a magnesium compound, and water to form a slaked mixture; combining the slaked mixture with carbon dioxide; and precipitating the particulate mineral; wherein a bulk chemical composition of the particulate mineral has a magnesium content within 5% of a magnesium content of a surface chemical composition of the particulate mineral; and wherein the particulate mineral has a steepness value ranging from about 20 to about 80. In at least one example, the particulate mineral thus prepared may comprise a surface magnesium content ranging from about 7% to about 80% by weight, with respect to the total weight of the particulate mineral.

Further, for example, the present disclosure includes a method of preparing a particulate mineral, the method comprising precipitating magnesium calcium carbonate to form the particulate mineral; wherein a bulk chemical composition of the particulate mineral has a magnesium content within 5% of a magnesium content of a surface chemical composition of the particulate mineral; and wherein the particulate mineral has a steepness value ranging from about 20 to about 80. In at least one example, precipitating the magnesium calcium carbonate includes combining lime, a magnesium compound, and water to form a slaked mixture; and combining the slaked mixture with carbon dioxide to precipitate the particulate mineral. In at least one example, precipitating the magnesium calcium carbonate includes combining lime, a magnesium compound, and water to form a slaked mixture; and combining the slaked mixture with soda ash to precipitate the particulate mineral. In at least one example, precipitating the magnesium calcium carbonate includes combining lime, a magnesium compound, and water to form a first mixture; combining the first mixture with ammonium chloride to form a second mixture; and combining the second mixture with soda ash or ammonium carbonate to precipitate the particulate mineral. In at least one example, precipitating the magnesium calcium carbonate includes combining calcium chloride, magnesium chloride, and lime to form a slaked mixture, and precipitating the particulate mineral from the slaked mixture. The particulate mineral may comprise, for example, from about 7% to about 80% magnesium by weight, with respect to the total weight of the particulate mineral. The particulate mineral may have an average particle diameter ranging from about 3 μm to about 80 μm and/or the magnesium may be uniformly distributed throughout the particulate mineral.

The present disclosure further includes a method of treating a well with the compositions and/or particulate minerals herein. The method may comprise adding a fluid to a particulate mineral to produce a drilling fluid, and introducing the drilling fluid into the well, wherein the particulate mineral comprises calcium carbonate and magnesium, wherein the particulate mineral comprises from about 7% to about 80% magnesium by weight, with respect to the total weight of the particulate mineral, and wherein a bulk chemical composition of the particulate mineral has a magnesium content within 5% of a magnesium content of a surface chemical composition of the particulate mineral. In some aspects, the method may comprise circulating the drilling fluid in the well, wherein the drilling fluid reduces fluid loss in the well. The drilling fluid may comprise a water-based liquid, an oil-based liquid, or an oil-water liquid mixture, e.g., having a particulate mineral concentration ranging from about 1 kg/m³ to about 200 kg/m³, such as from about 50 kg/m³ to about 150 kg/m³, or from about 100 kg/m³ to about 175 kg/m³. The particulate mineral of the drilling fluid may have any of the features or characteristics of particulate minerals discussed above or elsewhere herein.

### DETAILED DESCRIPTION

Particular aspects of the present disclosure are described in greater detail below. The terms and definitions provided herein control, if in conflict with terms and/or definitions incorporated by reference.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.”

As used herein, the singular forms “a,” “an,” and “the” include plural reference unless the context dictates otherwise. The terms “approximately” and “about” refer to being nearly the same as a referenced number or value. As used herein, the terms “approximately” and “about” should be understood to encompass ±5% of a specified amount or value.

Compositions according to the present disclosure may comprise calcium carbonate (CaCO₃) in combination with at least one other material. The at least one other material may comprise, for example, magnesium (e.g., forming magnesium carbonate), a polymer, a copolymer, or a combination thereof. The calcium carbonate and other material(s) may be incorporated together in particle form, i.e., as a particulate mineral. For example, the dry particulate mineral may be in the form of a powder. The methods of preparing such particulate minerals herein may provide for control over the chemical and/or physical properties of the particles, e.g., such that the particulate minerals may be tailored for use in a given application.

For example, the particulate minerals (and compositions comprising such particulate minerals) herein may exhibit acid resistance, such that the particulate mineral releases less calcium carbonate over time relative to a particulate mineral comprising calcium carbonate alone. In some aspects of the present disclosure, the acid dissolution rate may be tailored by controlling the magnesium content of the particulate mineral. Additionally or alternatively, the particulate minerals may have a controlled surface and/or bulk chemical composition, a controlled surface reactivity, a relatively narrow particle size distribution (steepness value), a controlled surface area, a selected brightness value and/or color, and/or a selected hardness value.

The calcium carbonate of the particulate mineral may be obtained from naturally-occurring sources or may be synthetic. Natural sources of calcium carbonate include, for example, natural or raw deposits of limestone, chalk, and talc. Synthetic sources of calcium carbonate include, for example, calcium carbonate derived from a natural material (e.g., a natural source of calcium oxide or calcium hydroxide) or a man-made material (e.g., post-consumer materials, such as carpet). In some examples herein, a post-consumer material may serve as a source of both the calcium carbonate and the one or more other materials of the particulate mineral, e.g., the post-consumer material comprising carbonate, magnesium, a polymer, a copolymer, or a combination thereof.

In some aspects of the present disclosure, the particulate mineral may be prepared synthetically by a precipitation process. In other aspects of the present disclosure, the particulate mineral may be prepared by grinding calcium carbonate particles with the other material(s), such that the other material(s) chemically react with, or are otherwise associated with, the surface of the calcium carbonate particles. Further, the particulate mineral may be prepared by a combination of precipitation and grinding processes.

In some aspects of the present disclosure, the compositions herein may comprise calcium carbonate in combination with magnesium, e.g., forming magnesium calcium carbonate. Without being bound by theory, it is believed that magnesium may provide for, or at least contribute to, the acid resistance of particulate minerals herein, e.g., by delaying the rate at which calcium carbonate degrades or dissolves in an acidic environment. For example, the acid dissolution rate of the particulate mineral may decrease with increasing magnesium content. The magnesium calcium carbonate may have the formula MgₓCO₃Ca_{y}CO₃ (i.e., MgₓCa_{y}(CO₃)₂), wherein x and y are greater than zero. In at least one example, x may range from 2 to 80, and y may range from 20 to 95. In another example, x may range from 10 to 70, and y may range from 25 to 90. In yet another example, x may range from 6 to 80 and y may range from 30 to 95. In some examples, x may be greater than y. The magnesium calcium carbonate may be synthetic, i.e., not naturally-occurring. For example, the selection of x and y of the particulate minerals herein may exclude a ratio of 1:1 (x:y) (dolomite). Synthetic MgₓCO₃Ca_{y}CO₃, may be produced, e.g., by a precipitation process and/or by a surface reaction as discussed below. Exemplary formulae of particulate minerals according to the present disclosure include, but are not limited to, Mg₍₂₋₈₀₎Ca₍₂₀₋₉₅₎(CO₃)₂, Mg₍₁₀₋₇₀₎Ca₍₂₅₋₉₀₎(CO₃)₂, Mg₍₂₀₋₆₀₎Ca₍₃₀₋₈₅₎(CO₃)₂, Mg₍₃₀₋₅₀₎Ca₍₂₀₋₉₀₎(CO₃)₂, Mg₍₆₋₈₀₎Ca₍₂₀₋₃₀₎(CO₃)₂, and Mg₍₅₀₋₇₀₎Ca₍₇₀₋₉₄₎(CO₃)₂.

Exemplary synthetic methods of preparing the particulate minerals herein may precipitate the particulate mineral from a solution. For example, a natural source of carbonate such as limestone, or a post-consumer material comprising carbonate, may be calcined to produce calcium oxide (CaO) (quicklime). The calcium oxide then may be combined with water to form calcium hydroxide (Ca(OH)₂) as a slaked mixture (slaked lime). When preparing a magnesium calcium carbonate particulate mineral, a source of magnesium may be added to the limestone or post-consumer material, the calcium oxide, or the calcium hydroxide. Additionally or alternatively, a source of magnesium may be added during subsequent preparation steps.

After producing the calcium hydroxide (which may include magnesium, in some examples), various processes may be used to convert the calcium hydroxide to calcium carbonate. In at least one exemplary method, the calcium hydroxide may be combined with carbon dioxide, at which point calcium carbonate may precipitate from solution. This process may be advantageous in that it typically does not yield by-products, thus providing control over the properties and purity of the calcium carbonate product. In another exemplary method, the calcium chloride may be combined with sodium carbonate (Na₂CO₃) (also called soda ash) to produce, by double decomposition (decomposition of the chloride and carbonate salts), precipitated calcium carbonate and a solution of sodium hydroxide. The sodium hydroxide may be substantially completely separated from the calcium carbonate. In yet another exemplary method, the calcium hydroxide may be combined with ammonium chloride (NH₄Cl) to produce a calcium chloride (CaCl₂) solution and ammonia gas. The calcium chloride solution then may be combined with sodium carbonate to produce, by double decomposition, precipitated calcium carbonate and a solution of sodium chloride.

In another exemplary method, the particulate mineral may be prepared by combining a source of calcium sulfate (CaSO₄) (including, e.g., natural sources such as gypsum) with ammonium carbonate ((NH₄)₂CO₃) or ammonium bicarbonate (NH₄HCO₃) to produce an ammonium sulfate ((NH₄)₂SO₄) solution and precipitated calcium carbonate. When preparing a magnesium calcium carbonate particulate mineral, a source of magnesium such as magnesium sulfate (MgSO₄) may be added to the calcium sulfate to yield magnesium calcium carbonate.

In another exemplary method, the particulate mineral may be prepared by combining calcium chloride with ammonium carbonate to produce an ammonium chloride solution and precipitated calcium carbonate. When preparing a magnesium calcium carbonate particulate mineral, a source of magnesium such as magnesium chloride (MgCl₂) may be added to the calcium sulfate to yield magnesium calcium carbonate.

In another exemplary method, the particulate mineral may be prepared by combining calcium chloride with magnesium chloride and a source of calcium oxide (lime), e.g., from limestone, chalk, or talc. The chloride/lime mixture then may be combined with sodium carbonate to produce precipitated magnesium calcium carbonate and a solution of sodium chloride.

Varying the reaction parameters of the above precipitation processes may provide for specific properties of the resulting calcium carbonate precipitate or magnesium calcium carbonate precipitate, such as particle size, particle size distribution, surface area, and the surface and/or bulk chemical composition. For example, a targeted particle surface area (e.g., less than 40 m²/g, or from 10 m²/g to 40 m²/g) and particle size distribution may be controlled by adjusting reaction parameters such as temperature, reaction time, and the reactant compositions. The relative amount of calcium and magnesium in the final carbonate mineral may be controlled by adjusting the relative amounts of the reactants.

By precipitating the magnesium calcium carbonate onto an existing particulate such as a ground calcium carbonate, a precipitated calcium carbonate, or a magnesium calcium carbonate having a low magnesium content, the surface of the resulting particulate product may be adjusted to have a higher magnesium content as compared to the bulk magnesium content.

Particle size may be characterized in terms of the diameter of a sphere of equivalent diameter (“equivalent spherical diameter” (ESD)) that sediments through a fully dispersed suspension of the particles in an aqueous medium. For example, a SEDIGRAPH 5100 instrument (Micromeretics Corp.) may be used to obtain the particle size distribution by plotting the cumulative percentage by weight of particles having a given ESD. For example, d₅₀ is the particle ESD at which 50% by weight of the particles have a smaller ESD. The steepness of a particle size distribution is defined as the ratio d₃₀/d₇₀×100. This ratio may be derived from the slope of a particle size distribution curve of particle diameter (x-axis) vs. cumulative weight percentage of particles (y-axis). A wide size distribution provides a low steepness value, whereas a narrow size distribution provides a high steepness value. The particulate minerals herein may have a relatively high steepness value, e.g., ranging from about 20 to about 80, such as from about 60 to about 80, or from about 70 to about 80.

The average particle size (average diameter) may range from about 3 μam to about 80 μm, such as from about 5 μm to about 60 μm, about 5 μm to about 50 μm, about 5 μm to about 10 μm, about 10 μm to about 25 μm, or about 40 μm to about 60 μm. Further, in some aspects of the present disclosure, the surface area of the particles may be controlled to provide for beneficial acid resistance characteristics. A smaller surface area may help to maximize acid resistance by reducing the amount of surface in contact with an acidic environment. For example, the particulate mineral may have a BET surface area (i.e., a surface area measured according to the Brunauer, Emmett, and Teller method) less than about 40 m²/g or less than about 20 m²/g, e.g., a BET surface area ranging from about 0.5 m²/g to about 20 m²/g, from about 0.5 m²/g to about 10 m²/g, or from about 5 m²/g to about 15 m²/g. In some aspects of the present disclosure, the particles may undergo one or more surface treatment processes to facilitate acid resistance. For example, the particulate mineral formed by a precipitation process may have a surface area greater than 40 m²/g, and may be subjected to one or more surface treatment processes to render the surface less susceptible to degradation under acidic conditions.

The foregoing precipitation processes may produce a particulate mineral comprising at least 95% by weight magnesium calcium carbonate with respect to the total weight of the particulate mineral, i.e., less than 5% by weight of impurities or other components. For example, the particulate mineral may comprise at least 96% by weight, at least 97% by weight, at least 98% by weight, or at least 99% by weight magnesium calcium carbonate. In some examples, the particulate mineral may comprise from 99% to 100% by weight magnesium calcium carbonate by weight.

In some aspects of the present disclosure, it may be desirable to include materials other than magnesium calcium carbonate in the particulate mineral. For example, the particulate mineral may comprise from about 70% to about 100% by weight magnesium calcium carbonate and from 0 to about 30% by weight other material(s), with respect to the total weight of the particulate mineral, such as from about 80% to about 90% by weight magnesium calcium carbonate and from about 10% to about 20% by weight other material(s). Depending on the type and amount of materials incorporated into the magnesium calcium carbonate, the particulate mineral may form composite particles. Without being bound by theory, it is believed that incorporating one or more other materials into the magnesium calcium carbonate on the surface and/or in the bulk of the particulate mineral may block sites that otherwise may react in an acidic environment to degrade or dissolve the particulate mineral. Such reaction sites may include, for example, cracks, pores, or fissures in the surfaces of the particles. In some examples, the particulate mineral may comprise magnesium calcium carbonate in combination with phosphoric acid and/or one or more hydrophobic or partially hydrophobic materials (including, e.g., polymers and/or copolymers).

According to some aspects of the present disclosure, for example, a compound comprising one or more phosphate groups, such as phosphoric acid, may be incorporated into the surface of the particulate mineral. Without being bound by theory, it is believed that the phosphate group(s) may react with carbonate at the surface of the particulate mineral, forming a chemical bond that may contribute to the acid resistance of the particulate mineral. Phosphoric acid or other compounds having phosphate groups may be reacted with the surface of the particulate mineral following a precipitation process and/or during a grinding process, e.g., via ionic interactions.

Further, for example, the particulate mineral may comprise magnesium calcium carbonate in combination with one or more polymers or copolymers chosen from an acrylic polymer, a copolymer of styrene and butadiene, a copolymer of acrylonitrile and butadiene, a co-polymer of acrylic acid and maleic anhydride, a copolymer of diisobutylene and maleic anhydride, maleated butadiene, maleated polyethylene, maleated polypropylene, or a combination thereof. According to some aspects of the present disclosure, for example a copolymer of acrylic acid and maleic anhydride and/or a copolymer of diisobutylene and maleic anhydride may be incorporated into the surface of the particulate mineral. Thus, a hydrophobic or partially hydrophobic surface treated particulate material may be produced. In at least one example, the particulate mineral may comprise a styrene-butadiene and acrylonitrile butadiene copolymer mixture, such as latex. In at least one example, the particulate mineral may comprise a hydrophilic/hydrophobic copolymer formed from an alkene monomer and a carboxylic acid anhydride monomer, such as a diisobutylene maleic anhydride polymer. The polymer or copolymer may be incorporated into the particulate mineral during any of the precipitation processes and/or grinding processes discussed herein. For example, the polymer or copolymer may be a component of a post-consumer material from which the particulate mineral is derived, or may be added during one or more steps of a precipitation or grinding process as described herein.

The particulate mineral prepared according to the precipitation processes herein may have a substantially consistent chemical composition, e.g., wherein the magnesium is uniformly or evenly distributed throughout the bulk and/or the surface of the particulate mineral. For example, the magnesium content of the surface of the particulate mineral as compared to the bulk may differ by less than 10%, less than 5%, or less than 1%. In some examples, the bulk chemical composition of the particulate mineral may have a magnesium content within 10%, within 5%, or within 1% of the magnesium content of the surface chemical composition. Further, in some examples, the chemical composition of the surface and the bulk of the particulate mineral may differ by less than 1%, meaning that the composition of the surface and the bulk is the same. The surface chemical composition of the particulate mineral (e.g., within the outer 0-10 nm) may be measured, for example, by x-ray photoelectron spectroscopy (XPS). The bulk chemical composition of the particulate mineral may be measured, for example, by X-ray fluorescence (XRF) or energy-dispersive X-ray spectroscopy (EDS or EDX).

The particulate mineral may be prepared by grinding calcium carbonate with a suitable grinding agent or dispersant. The calcium carbonate may be natural (e.g., a natural deposit of limestone, chalk, or marble) or synthetic (e.g., precipitated or recycled calcium carbonate). The grinding agent or dispersant may comprise a polymer or copolymer. During the grinding process, the polymer or copolymer may react chemically and/or associate physically with the surface of the calcium carbonate particles, such that the resulting particulate mineral may have properties different from the properties of the calcium carbonate alone. For example, the particulate mineral may have an acid dissolution profile different from the acid dissolution profile of the calcium carbonate particles alone.

Grinding may be performed in a dry milling system or in an aqueous suspension, and may provide a desired particle size and/or particle size distribution. In some aspects, the particulate mineral may be subjected to a particle size classification step after grinding to produce the desired particle size or size distribution. The ground particulate mineral may have an average particle diameter ranging from about 3 μm to about 80 μm, such as from about 5 μm to about 50 μm, from about 5 μm to about 10 μm, or from about 20 μm to about 30 μm. The ground particulate mineral may have a steepness value ranging from about 20 to about 80, from about 40 to about 60, or from about 60 to about 80. The amount of grinding agent may range from about 0.2% by weight to about 10.0% by weight, such as from about 0.2% to about 5.0% by weight, or from about 0.5% to about 5.0% by weight, relative to the weight of the calcium carbonate particles. Exemplary grinding agents include, but are not limited to, hydrophilic/hydrophobic copolymers and magnesium neutralized polymeric dispersants.

In at least one example, the grinding agent may comprise a hydrophilic/hydrophobic copolymer formed from an alkene monomer and a carboxylic acid anhydride monomer, such as a copolymer of diisobutylene and maleic anhydride. For example, the particulate mineral may be prepared by grinding calcium carbonate particles with the diisobutylene-maleic anhydride copolymer, such that the copolymer is chemically and/or physically associated with the calcium carbonate. Thus, a hydrophobic or partially hydrophobic surface treated particulate material may be produced. The molar ratio of diisobutylene to maleic anhydride in the copolymer may be 1:1.

In at least one example, the grinding agent may comprise a magnesium neutralized polymer or copolymer. For example, the particulate mineral may be prepared by grinding calcium carbonate particles with a magnesium neutralized polymer or copolymer, such that the polymer or copolymer is chemically and/or physically associated with the calcium carbonate. In at least one example, the magnesium neutralized polymeric dispersant may react with the surface of at least a portion of the calcium carbonate particles to form MgₓCO₃Ca_{y}CO₃, wherein x and y are each greater than zero. In at least one example, x may range from 2 to 80, and y may range from 20 to 95. In another example, x may range from 10 to 60, and y may range from 40 to 75. In some examples, x may be greater than y. The entire surface of the particulate mineral produced by grinding, or only a portion thereof (a portion of the surface of each particle), may comprise MgₓCO₃Ca_{y}CO₃.

The polymeric grinding agent/dispersant may comprise an anionic polymer of acrylic acid or methacrylic acid, a copolymer of acrylic or methacrylic acid with an alkyl acrylate or alkyl methacrylate, polyacrylamide, poly(vinyl alcohol), or oligostyrenesulfonate. The source of magnesium ions may be any suitable magnesium compound, including, e.g., magnesium hydroxide or a magnesium salt, such as an acetate, carbonate, chloride, citrate, cyanide, fluoride, nitrate, nitrite, phosphate or sulfate of magnesium.

The source of magnesium ions may be provided before and/or after the anionic polymeric dispersant is combined with the calcium carbonate. For example, the magnesium ions may be combined with the polymeric dispersant before grinding of the calcium carbonate particles, such that the anionic polymeric dispersant has the desired level of neutralization before it is combined with the calcium carbonate particles. In other examples, the source of magnesium ions may be provided when the anionic polymeric dispersant is already combined with the calcium carbonate, such that the anionic polymeric dispersant reaches the desired level of neutralization after combination with the calcium carbonate. For example, the source of magnesium ions may be provided during grinding of the calcium carbonate particles, such that the anionic polymeric dispersant reaches the desired level of neutralization during grinding.

According to some aspects of the present disclosure, the particulate minerals may be generally white in color with a GE brightness (i.e., directional brightness defined by the TAPPI test method T452) greater than 60. For example, particulate minerals prepared according to the precipitation and/or grinding processes herein may have a GE brightness ranging from about 60 to about 90, from about 70 to about 90, or from about 80 to about 90.

As mentioned above, the particulate minerals herein may exhibit acid resistance, e.g., such that the particulate mineral releases less calcium carbonate within a given period of time, relative to a particulate mineral comprising calcium carbonate alone. The chemical and/or physical properties of the particulate mineral may be tailored to provide a suitable acid resistance for a desired application, such as incorporation into a drilling fluid or an article, as discussed below. For example, incorporation of a relatively high magnesium content and/or additional materials such as polymers and/or copolymers may result in particulate minerals with increased acid resistance.

The acid resistance of a particulate mineral may be measured by subjecting the particulate mineral to a specific acidic environment and monitoring the degradation or dissolution of calcium carbonate and/or other material(s) from the particulate mineral over time to obtain an acid dissolution profile.

In a first exemplary method, the acid dissolution profile of the particles according to the present disclosure may be measured by suspending about 1 g of the particles in about 100 ml of an aqueous solution comprising deionized water, about 11.8 g/L of citric acid monohydrate, about 2.6 g/L, NaCl, and about 2.7 g/L of NaOH. The pH of this aqueous solution before adding the particles is usually about 3.8, e.g., 3.80±0.07. The time required to increase the pH of the mixture relates to dissolution of the particles, such that the increase in pH over time corresponds to the acid dissolution profile. The decomposition of carbonate (including, e.g., crude CaₓCO₃Mg_{y}CO₃) under acidic conditions is understood to occur according to the following simplified reaction scheme:

CaCO₃₍ₛ₎+2H⁺_{(aq)}→Ca²⁺_{(aq)}+2HCO₃⁻_{(aq)} Equation 1

2HCO₃⁻_{(aq)}→OH⁻_{(aq)}+CO_{2(g)}. Equation 2

The consumption of hydrogen ions therefore increases the pH, and the change in pH may be monitored as a function of time. According to some aspects of the present disclosure, the particulate mineral as measured by the foregoing first method may result in a solution having a pH below 7.0 after 30 minutes or more of exposure to the acidic solution. For example, the solution may increase from an initial pH of about 3.8 to a between 3.8 and 7.0, between 3.8 and 6.8, or between 3.8 and 5.9 after 30 minutes. Further, the pH of the solution after 40 minutes, after 45 minutes, or after 50 minutes may be below 7.0, e.g., a pH between 3.8 and 7.0, between 3.8 and 6.8, or between 3.8 and 5.9.

In a second exemplary method herein for measuring an acid dissolution profile for a hydrophobic or partially hydrophobic particulate material, 1 g of the particles may be suspended in a solution comprising about 20 ml of toluene and about 80 ml of the aqueous solution (i.e., an aqueous solution comprising deionized water, about 11.8 g/L of citric acid monohydrate, about 2.6 g/L NaCl, and about 2.7 g/L of NaOH). Again, the increase in pH over time corresponds to the acid dissolution profile of the particles, wherein the decomposition of carbonate is understood to occur according to Equations 1 and 2 above. According to some aspects of the present disclosure, the particulate mineral as measured by the foregoing second method may result in a solution having a pH below 7.0 after 30 minutes or more of exposure to the acidic solution. For example, the solution may increase from an initial pH of about 3.8 to a pH between 3.8 and 7.0, between 3.8 and 6.8, or between 3.8 and 5.9 after 30 minutes. Further, the pH of the solution after 40 minutes, after 45 minutes, or after 50 minutes may be below 7.0, e.g., a pH between 3.8 and 7.0, between 3.8 and 6.8, or between 3.8 and 5.9.

In a third exemplary method herein, the acid dissolution profile of the particulate mineral may be measured with a standard USP Dissolution Apparatus 2—Paddle used to test dissolution of oral pharmaceuticals. For testing of the particulate minerals herein, the paddle of the apparatus may induce stirring of an acidic solution at a predetermined initial pH (e.g., pH 3.9), the stirring speed being held at a constant, controlled rate (e.g., about 50 rpm). Any suitable acid may be used, including, e.g., hydrochloric acid (HCl). Buffers may not be used for the testing unless otherwise specified. In at least one example, the particulate minerals herein may have an acid dissolution profile as measured by the foregoing third method wherein the particulate mineral releases less than about 50%, less than about 25%, or less than about 20% calcium carbonate by weight with respect to the total weight of the particulate mineral within 20 minutes when added to an acidic solution at pH 3.9.

In a fourth exemplary method herein, the acid mediated dissolution of the particulate mineral may be measured by suspending 3 g of the particles in a mixture comprising 200 ml of deionized water and 3 ml of formic acid (99%), and sealing the container. The decomposition of carbonate under acidic conditions is understood to occur according to Equations 1 and 2 above. The released CO₂ gas may be collected and transferred to a second sealed container (e.g., a sealed Erlenmeyer flask) that contains 500 ml of non-polar oil. The second container may be connected to a graduated cylinder to collect the oil replaced by the CO₂ gas. The amount of time required to replace 200 ml of the oil may be recorded as a measurement of acid dissolution characteristics of the carbonate particles. A longer amount of time required to replace the 200 ml of oil provides an indication of relatively slow production of CO₂ gas, and thus a relatively slower dissolution of carbonate particles,

According to some aspects of the present disclosure, the particulate mineral as measured by the foregoing fourth method may have an acid dissolution profile wherein it takes longer than 60 minutes to replace 200 ml of oil. For example, the acid dissolution profile of the particulate mineral may correspond to a time of more than 90 minutes, more than 120 minutes, more than 180 minutes, or more than 240 minutes to collect 200 ml of oil. For example, the time to collect 200 ml of oil may range from about 60 minutes to about 300 minutes, from about 60 minutes to about 240 minutes, from about 60 minutes to about 120 minutes, from about 60 minutes to about 90 minutes, or from about 120 minutes to about 240 minutes.

The compositions herein may comprise a mixture or blend of carbonate particles having different chemical compositions and/or different particle size distributions. For example, the composition may comprise a first particulate mineral of magnesium calcium carbonate (which may include any of the characteristics of magnesium calcium carbonate particulate minerals disclosed herein), and a second particulate mineral different from the first particulate mineral, wherein the second particulate mineral may comprise calcium carbonate without magnesium, or magnesium calcium carbonate having a different chemical composition than the first particulate mineral. In some aspects of the present disclosure, the composition may comprise a mixture or blend of three or more carbonate particulate minerals of different chemical compositions. The ratio of a first particulate material to a second particulate material may range from 97:3 to 3:97, or from 67:33 to 33:67, or may be 50:50.

According to some aspects of the present disclosure, the composition may comprise a first particulate mineral for which the surfaces of the particles have been treated by a physical and/or chemical process, and a second particulate mineral for which the surfaces of the particles have not been treated. The first particulate mineral may be prepared according to any of the surface treatment processes disclosed herein, or any other suitable surface treatment. For example, the first particulate mineral may be treated by grinding calcium carbonate particles with a magnesium neutralized polymer or copolymer to produce MgₓCO₃Ca_{y}CO₃on the particles' surfaces, wherein x and y are each greater than zero. Further, for example, the first particulate mineral may be prepared by reacting the surfaces of particles prepared by a precipitation and/or grinding process with a phosphate compound, a polymer, a copolymer, a grinding agent, a dispersing agent, another hydrophobic or partially hydrophobic material, or a combination thereof. The second particulate mineral may be prepared by a precipitation and/or grinding process as disclosed herein.

In some aspects, the composition may comprise a first particulate mineral and a second particulate mineral, wherein the first particulate mineral has a smaller average particle diameter or smaller ESD than the second particulate mineral. For example, the first particulate mineral may comprise surface-treated carbonate particles (e.g., surface-treated magnesium calcium carbonate particles, or surface-treated calcium carbonate particles) having a d₅₀ particle diameter ranging from about 0.5 μm to about 75 μm, such as from about 1 μm to about 15 μm, from about 1 μm to about 60 μm, from about 1 μm to about 50 μm, or from about 1 μm to about 30 μm. The second particulate mineral may comprise carbonate particles for which the surfaces of the particles have not been treated (e.g., magnesium calcium carbonate particles, or calcium carbonate particles) having a d₅₀ particle diameter ranging from about 3 μm to about 75 μm, such as from about 10 μm to about 75 μm, from about 12 μm to about 75 μm, from about 20 μm to about 75 μm, from about 25 μm to about 75 μm, from about 30 μm to about 75 μm, from about 5 μm to about 50 μm, or from about 10 μm to about 50 μm. In at least one example, the first particulate mineral may comprise calcium carbonate particles ground with a magnesium neutralized polymer or copolymer to produce MgₓCO₃Ca_{y}CO₃on the particles' surfaces, and the second particulate mineral may comprise calcium carbonate ground without a magnesium neutralized polymer or copolymer.

The particulate minerals and blends of particulate minerals herein may be combined with a liquid, such as a water-based (aqueous) liquid, an oil-based liquid, or an oil-water mixture. For example, the liquid may comprise water, an organic liquid such as a liquid hydrocarbon or hydrocarbon mixture, or a hydrocarbon-water emulsion. The particulate mineral(s) and liquid may form a slurry, e.g., with the particles suspended in the liquid, useful as a working fluid for various applications. For example, the working fluid may be used in hydrocarbon extraction, such as during hydraulic fracturing (fracking) or other oil/gas extraction, e.g., during the drilling and/or operation of wells. In some examples, the concentration of the particulate minerals) in the working fluid may range from about 1 kg/m³ to about 200 kg/m³, such as from about 5 kg/m³ to about 100 kg/m³, from about 50 kg/m³ to about 150 kg/m³, from about 25 kg/m³ to about 75 kg/m³, or from about 100 kg/m³ to about 175 kg/m³.

Working fluids according to the present disclosure may provide one or more of the following uses: preventing or minimizing fluid loss in or into a well; stabilizing a rock formation through which a well is being drilled; fracturing a rock formation; displacing another fluid in a well; suspending, transporting, and/or removing debris during drilling or extraction; lubrication and/or cooling of drill bit cutting surfaces or other tools; controlling fluid pressure in a formation (e.g., to prevent blowouts or otherwise provide stability to the formation); maintaining well stability; cleaning a well; testing a well; emplacing a packer fluid; increasing the density of drilling mud; abandoning a well; and/or preparing a well for abandonment, among other methods of treating a well and/or formation.

In some aspects, for example, the working fluid may be a drilling fluid, e.g., a drill-in, completion, or work over fluid. The drilling fluid may be introduced and circulated in a well to prevent or otherwise minimize fluid loss in the well during fracking. For example, the particles in the drilling fluid may serve as a bridging agent or lost-circulation agent. As discussed above, the particulate mineral may have a controlled acid dissolution rate, such that the particulate mineral may remain in place within a well or formation until exposed to a sufficiently acidic environment to dissolve or degrade the particulate mineral. For example, a drilling fluid in accordance with the present disclosure may be introduced into a well and circulated in the well to form a residue. When removal of the residue is desired, an acid or acidic substance may be introduced into the well to dissolve, degrade, or otherwise break up the residue.

Compositions according to the present disclosure may comprise a mineral in a form other than particles. For example, a particulate mineral as described above may be formed into various articles. Non-limiting examples of such articles may include plastic films, flexible and rigid packaging materials, cement structures, architectural structures, countertops, flooring, and other structures with working surfaces. Properties of the particulate mineral (e.g., acid resistance, brightness) may provide the article with similar beneficial properties. For example, a countertop formed of the particulate mineral may have an acid resistance to provide for longevity as a working surface and/or an appearance in color and/or brightness to appeal to a consumer. Further, for example, incorporating the particulate mineral in packaging material, e.g., a plastic, may reduce manufacturing costs while providing one or more beneficial properties to the packaging, such as acid resistance and/or brightness.

According to some aspects of the composition, the composition may be an article comprising magnesium calcium carbonate, e.g., the composition comprising from about 7% to about 80% magnesium by weight, or from about 40% to about 50% by weight, with respect to the total weight of the composition. Additionally or alternatively, the composition may have a GE brightness greater than 60, such as a GE brightness ranging from about 60 to about 90, from about 70 to about 90, or from about 80 to about 90. In some examples, the composition may be acid resistant.

In an exemplary manufacturing process, the composition may be a structure prepared by combining a magnesium calcium carbonate particulate mineral (e.g., produced according to a precipitation or grinding process as disclosed herein) with a suitable adhesive or binder, such as a polymer resin, e.g., epoxy or polyester resin. For example, the composition may comprise from about 90% to about 97% by weight particulate mineral and from about 10% to about 3% by weight adhesive with respect to the total weight of the composition. The particulate mineral and adhesive may be homogeneously mixed, together with any additives such as UV stabilizers, and formed into a desired shape, such as a countertop or other structure having a flat surface. The mixture then may be heated under pressure to cure or otherwise set/harden the resin. One or more surfaces of the structure may be finished, e.g., polished, if desired.

In another exemplary manufacturing process, the composition may be a packaging material prepared by combining a magnesium calcium carbonate particulate mineral (e.g., produced according to a precipitation or grinding process as disclosed herein) with a plastic material. Exemplary plastics may include, but are not limited to, polyethylene and polypropylene (including biaxially oriented polypropylene, BOPP), among other polyolefins, polyvinyl chloride, polyester, and any combination thereof. For example, the composition may comprise from about 10% to about 40% by weight particulate mineral and from about 60% to about 90% by weight plastic material with respect to the total weight of the composition. The packaging material may be prepared by any suitable molding process, such as injection molding, blow molding, extrusion molding, rotational molding, and compression molding.

Aspects of the present disclosure are further illustrated by reference to the following, non-limiting numbered exemplary embodiments.

1. A composition comprising a particulate mineral that comprises calcium carbonate and magnesium; wherein the particulate mineral comprises from about 7% to about 80% magnesium by weight, with respect to the total weight of the particulate mineral; wherein a bulk chemical composition of the particulate mineral has a magnesium content within 5% of a magnesium content of a surface chemical composition of the particulate mineral; and wherein the particulate mineral has a steepness value ranging from about 20 to about 80.

2. The composition according to embodiment 1, wherein the bulk chemical composition of the particulate mineral is the same as the surface chemical composition of the particulate mineral.

3. The composition according to embodiment 1 or 2, wherein the magnesium is uniformly distributed throughout the particulate mineral.

4. The composition according to any of embodiments 1-3, wherein the particulate mineral has a formula MgₓCO₃Ca_{y}CO₃, wherein x and y are each greater than zero, and x is not 1 if y is 1.

5. The composition according to embodiment 4, wherein x ranges from 2 to 80 and y ranges from 20 to 95.

6. The composition according to any of embodiments 1-5, wherein the particulate mineral comprises from about 40% to about 60% magnesium by weight, with respect to a total weight of the particulate mineral.

7. The composition according to any of embodiments 1-6, wherein the particulate mineral has an average particle diameter ranging from about 3 μm to about 80 μm.

8. The composition according to any of embodiments 1-7, wherein the particulate mineral has an average particle diameter ranging from about 5 μm to about 10 μm.

9. The composition according to any of embodiments 1-8, wherein the particulate mineral has a BET surface area less than about 20 m²/g.

10. The composition according to any of embodiments 1-9, wherein the particulate mineral further comprises phosphoric acid.

11. The composition according to any of embodiments 1-10, wherein the particulate mineral further comprises a polymer or a co-polymer, the particulate mineral being in the form of composite particles.

12. The composition according to embodiment 11, wherein the polymer or the co-polymer comprises at least one of an acrylic polymer, a copolymer of styrene and butadiene, a copolymer of acrylonitrile and butadiene, a copolymer of diisobutylene and maleic anhydride, maleated butadiene, maleated polyethylene, maleated propylene, or a combination thereof.

13. The composition according to any of embodiments 1-12, wherein the particulate mineral comprises recycled calcium carbonate.

14. The composition according to any of embodiments 1-13, wherein the particulate mineral has a GE brightness ranging from about 60 to about 90.

15. The composition according to any of embodiments 1-14, wherein the particulate mineral is acid resistant.

16. The composition according to any of embodiments 1-15, wherein the particulate mineral has an acid dissolution profile corresponding to a pH less than 7.0 after 30 minutes of adding 1 g of the particulate mineral to 100 ml of an aqueous solution comprising citric acid monohydrate, sodium chloride, and sodium hydroxide, the aqueous solution having an initial pH of about 3.8.

17. The composition according to any of embodiments 1-16, wherein the composition is in the form of a powder.

18. The composition according to any of embodiments 1-16, further comprising a liquid, such that the composition forms a slurry.

19. A composition comprising a particulate mineral that comprises calcium carbonate and magnesium; wherein the particulate mineral comprises from about 7% to about 80% magnesium by weight, with respect to the total weight of the particulate mineral; wherein the particulate mineral has an acid dissolution profile corresponding to a pH between 3.8 and 6.8 after 60 minutes of adding 1 g of the particulate mineral to 100 ml of an aqueous solution comprising citric acid monohydrate, sodium chloride, and sodium hydroxide, the aqueous solution having an initial pH of about 3.8; and wherein the particulate mineral has a steepness value ranging from about 20 to about 80.

20. The composition according to embodiment 19, wherein, in the acid dissolution profile of the particulate mineral, the pH of the aqueous solution ranges from 3.8 to 5.9 after 120 minutes of adding the particulate mineral.

21. The composition according to embodiment 19 or 20, wherein at least one of a surface chemical composition or a bulk chemical composition of the particulate mineral has a formula MgₓCO₃Ca_{y}CO₃, wherein x and y are each greater than zero, and x is not 1 if y is 1.

22. The composition according to embodiment 21, wherein x ranges from 2 to 80 and y ranges from 20 to 95.

23. The composition according to any of embodiments 19-22, wherein the particulate mineral has an average particle diameter ranging from about 3 μm to about 80 μm.

24. The composition according to any of embodiments 19-23, wherein the particulate mineral is a first particulate mineral, the composition further comprising a second particulate mineral having a chemical composition different than a chemical composition of the first particulate mineral.

25. The composition according to embodiment 24, wherein the first particulate mineral has a d₅₀ particle diameter ranging from about 0.5 μm to about 75 μm, and the second particulate mineral has a d₅₀ particle diameter ranging from about 3 μm to about 75 μm.

26. The composition according to embodiment 24 or 25, wherein the second particulate mineral comprises ground calcium carbonate.

27. The composition according to any of embodiments 19-26, further comprising a water-based liquid, an oil-based liquid, or an oil-water liquid mixture.

28. A composition comprising a particulate mineral that comprises calcium carbonate and a copolymer chosen from a styrene-butadiene copolymer, an acrylonitrile butadiene copolymer, maleated butadiene, maleated polyethylene, maleated propylene, or a mixture thereof; wherein the particulate mineral comprises from about 7% to about 80% of the copolymer by weight, with respect to the total weight of the particulate mineral; wherein a bulk chemical composition of the particulate mineral has a copolymer content within 5% of a copolymer content of a surface chemical composition of the particulate mineral; and wherein the particulate mineral has a steepness value ranging from about 20 to about 80.

29. The composition according to embodiment 28, wherein the co-polymer comprises latex.

30. A composition comprising calcium carbonate and magnesium, wherein the magnesium is evenly distributed throughout the composition, and the composition comprises from about 7% to about 80% magnesium by weight, with respect to the total weight of the composition; wherein the composition is acid resistant; and wherein the composition has a GE brightness ranging from about 60 to about 90.

31. The composition according to embodiment 30, wherein the composition has a GE brightness ranging from about 80 to about 90.

32. The composition according to embodiment 30 or 31, wherein the composition comprises MgₓCO₃Ca_{y}CO₃, wherein x and y are each greater than zero, and x is not 1 if y is 1.

33. A particulate mineral comprising calcium carbonate and magnesium, wherein the particulate mineral is prepared by combining lime, a magnesium compound, and water to form a slaked mixture; combining the slaked mixture with carbon dioxide; and precipitating the particulate mineral; wherein a bulk chemical composition of the particulate mineral has a magnesium content within 5% of a magnesium content of a surface chemical composition of the particulate mineral; and wherein the particulate mineral has a steepness value ranging from about 20 to about 80.

34. The particulate mineral according to embodiment 33, wherein the particulate mineral comprises a surface magnesium content ranging from about 7% to about 80% by weight, with respect to the total weight of the particulate mineral.

35. A method of preparing the composition according to any of embodiments 1-32 or the particulate mineral according to embodiment 33 or 34.

36. The method of embodiment 35, comprising precipitating magnesium calcium carbonate to form the particulate mineral, wherein a bulk chemical composition of the particulate mineral has a magnesium content within 5% of a magnesium content of a surface chemical composition of the particulate mineral, and wherein the particulate mineral has a steepness value ranging from about 20 to about 80.

37. The method of embodiment 36, wherein precipitating the magnesium calcium carbonate includes combining lime, a magnesium compound, and water to form a slaked mixture; and combining the slaked mixture with carbon dioxide to precipitate the particulate mineral.

38. The method of embodiment 36, wherein precipitating the magnesium calcium carbonate includes combining lime, a magnesium compound, and water to form a slaked mixture; and combining the slaked mixture with soda ash to precipitate the particulate mineral.

39. The method of embodiment 36, wherein precipitating the magnesium calcium carbonate includes combining lime, a magnesium compound, and water to form a first mixture; combining the first mixture with ammonium chloride to form a second mixture; and combining the second mixture with soda ash or ammonium carbonate to precipitate the particulate mineral.

40. The method of embodiment 36, wherein precipitating the magnesium calcium carbonate includes combining calcium chloride, magnesium chloride, and lime to form a slaked mixture, and precipitating the particulate mineral from the slaked mixture.

41. A drilling fluid comprising the composition according to any of embodiments 1-32 or the particulate mineral of embodiment 33 or 34.

42. The drilling fluid of embodiment 41, wherein the drilling fluid comprises a liquid that is water-based, oil-based, or an oil-water mixture.

43. The drilling fluid of embodiment 41 or 42, wherein the drilling fluid has a particulate mineral concentration ranging from about 1 kg/m³ to about 200 kg/m³.

44. Use of the drilling fluid of any of embodiments 41-43 in treating a well.

45. The use of embodiment 44, wherein circulating the drilling fluid in the well reduces fluid loss in the well.

46. An article comprising the composition according to any of embodiments 1-32 or the particulate mineral of embodiment 33 or 34.

47. The article according to embodiment 46, wherein the article is a packaging material or a structure having a fiat working surface.

Other aspects and embodiments of the present disclosure will be apparent to those skilled in the art from consideration of the specification and practice of the examples and principles disclosed herein.

### EXAMPLE

The following example is intended to illustrate the present disclosure without, however, being limiting in nature. It is understood that the present disclosure encompasses additional aspects and embodiments consistent with the foregoing description and following examples.

### Example 1

A particulate mineral of magnesium calcium carbonate is prepared by combining CaCl₂ and/or lime with MgCl₂ in a reaction vessel with stirring. Then, Na₂CO₃ is added to the mixture with stirring, which results in precipitation of magnesium calcium carbonate as a white solid. The precipitated material is removed from solution and dried.

Particle size analysis (SEDIGRAPH 5100, Micromeretics Corp) of the precipitated material shows an average particle diameter of about 50 μm. The surface chemical composition of the precipitated material is analyzed by XPS, and the bulk chemical composition of the precipitated material is analyzed by XRF. The compositional analyses confirm the presence of calcium carbonate and magnesium carbonate and show a magnesium content of 10-11% throughout the particles.

It is intended that the specification and examples be considered as exemplary only, with a true scope and spirit of the present disclosure being indicated by the following claims.

1. A composition comprising a particulate mineral that comprises calcium carbonate and magnesium;
wherein the particulate mineral comprises from about 7% to about 80% magnesium by weight, with respect to the total weight of the particulate mineral;
wherein a bulk chemical composition of the particulate mineral has a magnesium content within 5% of a magnesium content of a surface chemical composition of the particulate mineral; and
wherein the particulate mineral has a steepness value ranging from about 20 to about 80.

2. The composition of claim 1, wherein the bulk chemical composition of the particulate mineral is the same as the surface chemical composition of the particulate mineral.

3. The composition of claim 1, wherein the magnesium is uniformly distributed throughout the particulate mineral.

4. The composition of claim 1, wherein the particulate mineral has a formula MgₓCO₃Ca_{y}CO₃, wherein x and y are each greater than zero, and x is not 1 if y is 1.

5. The composition of claim 4, wherein x ranges from 2 to 80 and y ranges from 20 to 95.

6. The composition of claim 1, wherein the particulate mineral comprises from about 40% to about 60% magnesium by weight, with respect to a total weight of the particulate mineral.

7. The composition of claim 1, wherein the particulate mineral has an average particle diameter ranging from about 3 μm to about 80 μm.

8. The composition of claim 1, wherein the particulate mineral has an average particle diameter ranging from about 5 μm to about 10 μm.

9. The composition of claim 1, wherein the particulate mineral has a BET surface area less than about 20 m²/g.

10. The composition of claim 1, wherein the particulate mineral further comprises phosphoric acid.

11. The composition of claim 1, wherein the particulate mineral further comprises a polymer or a co-polymer, the particulate mineral being in the form of composite particles.

12. The composition of claim 11, wherein the polymer or the co-polymer comprises at least one of an acrylic polymer, a copolymer of styrene and butadiene, a copolymer of acrylonitrile and butadiene, a copolymer of diisobutylene and maleic anhydride, maleated butadiene, maleated polyethylene, maleated propylene, or a combination thereof.

13. The composition of claim 1, wherein the particulate mineral comprises recycled calcium carbonate.

14. The composition of claim 1, wherein the particulate mineral has a GE brightness ranging from about 60 to about 90.

15. The composition of claim 1, wherein the particulate mineral is acid resistant.

16. The composition of claim 1, wherein the particulate mineral has an acid dissolution profile corresponding to a pH less than 7.0 after 30 minutes of adding 1 g of the particulate mineral to 100 ml of an aqueous solution comprising citric acid monohydrate, sodium chloride, and sodium hydroxide, the aqueous solution having an initial pH of about 3.8.

17. The composition of claim 1, wherein the composition is in the form of a powder.

18. The composition of claim 1, further comprising a liquid, such that the composition forms a slurry.

19. The composition of claim 18, wherein the composition is a drilling fluid,

20-51. (canceled).
